(19) United States
(12) Patent Application Publication
(10) Pub. No.: US 2011/0197271 A1
(43) Pub. Date: Aug. 11, 2011

(54) CARD BASED AUTHENTICATION SYSTEM AND METHOD FOR RELEASING STORED RENDERING JOBS

(75) Inventor: Kenneth James Buck, Webster, NY (US)

(73) Assignee: Xerox Corporation

(21) Appl. No.: 12/701,132

(22) Filed: Feb. 5, 2010

(51) Int. Cl. H04L 9/32

(52) U.S. Cl. 726/9

(57) ABSTRACT

An authentication system and method for securely releasing a stored rendering job utilizing an electronically readable card. The electronically readable card can be registered by entering network credential at a user interface associated with a MFD and the card can be validated before storing the card details into a MFD database. The card can be swiped with respect to a card reader associated with the MFD in order to authenticate a user based on the stored credential via an authentication server. The MFD can be unlocked if the card is recognized in order to provide access to an appropriate service. The rendering jobs associated with the user can be displayed and released immediately based on user selection.

### TECHNICAL FIELD

Embodiments are generally related to multifunction devices such as, printers, scanners, photocopy machines, and the like. Embodiments are also related to secure rendering techniques. Embodiments are additionally related to card based authentication systems and methods for releasing stored rendering jobs.

### BACKGROUND OF THE INVENTION

An MFD (Multifunction device) is a rendering device or office machine, which incorporates the functionality of multiple devices in a single apparatus or system, so as to allow a smaller footprint in a home or small business setting, or to provide centralized document management/distribution/production in the context of, for example, a large-office setting. A typical MFD may provide a combination of some or all of the following capabilities: printer, scanner, photocopier, fax machine, e-mail capability, and so forth.

Multiple users may share access to a single MFD via a network in a wide variety of environments such as, for example, corporate offices, universities, drug stores, libraries, computer labs and so forth. The documents in such settings are usually rendered in the order that they are sent to the MFD and left to be retrieved by the person rendering each specific document. Hence, it is desirable to prevent unauthorized use and to maintain confidentiality of electronic transmission, capture, and processing of electronic documents at such shared MFD as more personal information is recorded electronically.

The majority of prior art authentication processes for secure rendering employ a user to perform an authentication operation at the MFD. Such an authentication process is complex and requires manual entry of network credentials and an accounting solution for releasing the stored jobs. Also, such prior art approaches require a partner application, which runs on an external server to offer an authentication service. Accordingly, initiation of a rendering process is necessarily delayed, and the cost of managing the partner server application increases.

Based on the foregoing, it is believed that a need exists for an improved card based authentication system and method for releasing stored rendering jobs, as described in greater detail herein.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved method and system for configuring a multifunction device (MFD), such as a printer, scanner, photocopy machine, fax machine, etc., or a combination thereof.

It is another aspect of the disclosed embodiments to provide for an improved card based authentication system and method for releasing a stored rendering job.

It is a further aspect of the disclosed embodiments to provide for an improved system and method for registering a card by manually entering network credential at a user interface associated with a multifunction device.

The aforementioned aspects and other objectives and advantages can now be achieved as described herein. An authentication system and method for securely releasing a stored rendering job utilizing an electronically readable card (e.g. magnetic strip card, proximity card, smart card, credit card, etc) is disclosed. The electronically readable card can be registered by entering network credentials via a user interface associated with a MFD and the credentials can be validated before storing the card details into an MFD database. The card can be swiped with respect to a card reader associated with the MFD in order to authenticate a user based on the stored credential via an authentication server (LDAP, SMB, Kerberos, etc). The MFD can be unlocked if the card is recognized in order to provide access to an appropriate service. The rendering jobs associated with the user can be displayed and released immediately based on user selection.

The rendering job associated with a user name in a job header can be held at the MFD for release via the card swipe. The user name associated with the card can be compared with the user name of the stored rendering jobs in a job queue and the job associated with the user can be displayed after the card is recognized. The readable card emits a number which can be stored and linked to the user's network credentials. The database can be sized to accept a reasonable number of cards and such data can be cleared if the MFD is relocated. The network credentials cannot be shared with respect to other MFDs and the registration process must be performed to gain access to such MFDs.

The stored network credentials can be deleted if the credentials are not accessed for a predefined time period. If the user's credentials (password) are expired, the user can be prompted to re-enter network credentials and the previously stored data can be overwritten. Such card based authentication system provides increased capability and flexibility, reduced complexity, improved speed, accuracy and ease of use via card swipe. The system and approach described herein validates the user credentials before accepting the card into the database and securely stores authenticated user credentials so they need not be entered every time the MFD is utilized.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a multifunction device (MFD) coupled to a data-processing system through a network, in accordance with the disclosed embodiments;

FIG. 2 illustrates a block diagram of a card based authentication system associated with the multifunction device, in accordance with the disclosed embodiments;

FIG. 3 illustrates an exemplary view of a database associated with the multifunction device, in accordance with the disclosed embodiments;

FIG. 4 illustrates a high-level flow chart of operations illustrating logical operational steps of a method for securely releasing stored rendering jobs utilizing an electronically readable card, in accordance with the disclosed embodiments; and

FIG. 5A and FIG. 5B illustrate respective sequence diagrams for securely releasing the rendering job utilizing the electronically readable card, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

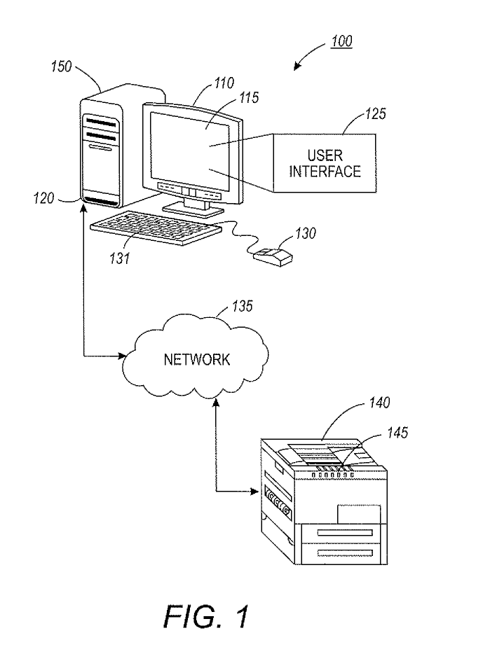

FIG. 1 is provided as an exemplary diagram of data processing environments in which embodiments of the present invention can be implemented. It should be appreciated that FIG. 1 is only exemplary and is not intended to assert or imply any limitation with regard to the environments in which aspects or embodiments of the present invention can be implemented. Many modifications to the depicted environments can be made without departing from the spirit and scope of the disclosed embodiments.

Referring to FIG. 1, system 100 includes a multifunction device 140 coupled to a data-processing system 110 through a network 135. The data-processing system 110 can be, for example, a computing device such as, for example, personal computer, a server, a computer workstation, a laptop computer or another computing apparatus or system (e.g., wireless cellular telephone, Smartphone, etc), and generally includes a central processor 120, a display device 115, a keyboard 131, and a pointing device 130 (e.g., mouse, track ball, pen device, or the like). Additional input/output devices, such as the multifunction device 140, may be included in association with the data-processing system 110 as desired.

Note that as utilized herein, the term multifunction device (including the acronym MFD) may refer to an apparatus or system such as a printer, scanner, fax machine, copy machine, etc., and/or a combination thereof. Preferably, MFD 140 is capable of multiple rendering functions such as printing, copying, scanning, faxing, etc. In some embodiments, MFD 140 can be implemented with a single rendering function such as printing. In other embodiments, MFD 140 can be configured to provide multiple rendering functions, such as scanning, faxing, printing and copying.

A non-limiting example of an MFD that can be utilized as MFD 140 is disclosed in U.S. Pat. No. 7,525,676, entitled “System and Method for Controlling Access to Programming Options of a Multifunction Device,” which issued on Apr. 28, 2009 to Robert J. Pesar. U.S. Pat. No. 7,525,676, which is incorporated herein by reference in its entirety, is assigned to the Xerox Corporation of Norwalk, Conn. Another non-limiting example of an MFD that can be utilized as MFD 140 is disclosed in U.S. Pat. No. 7,474,428, entitled “Multifunction Device System Using Tags Containing Output Information,” which issued on Jan. 6, 2009 to Morris-Jones, et al. U.S. Pat. No. 7,474,428, which is incorporated herein by reference in its entirety, is also assigned to the Xerox Corporation of Norwalk, Conn. An additional example of an MFD that can be utilized as MFD 140 is disclosed in U.S. Pat. No. 5,920,405, entitled “Multifunction Device With Printer Facsimile Contention Selection,” which issued on Jul. 6, 1999 to McIntyre, et al. U.S. Pat. No. 5,920,405, which is incorporated herein by reference in its entirety, is also assigned to the Xerox Corporation of Norwalk, Conn. Note that such MFDs are referenced herein for generally illustrative purposes and are not considered limiting features of the disclosed embodiments.

The data-processing system 110 can communicate with the MFD 140 through, for example, a computer network 135 or other networking configuration. Network 135 may employ any network topology, transmission medium, or network protocol, such as, for example, Ethernet, Internet, Intranet, etc. Network 135 may include connections, such as wired links, wireless communication links, fiber optic cables, USB components, and so forth. The MFD 140 includes a user interface 145, such as a panel menu. The panel menu can be employed to select features and enter other data in the MFD 140. Such interfaces may include, for example, touch screens having touch activated keys for navigating through an option menu or the like.

A MFD driver program can be installed at the data-processing system 110 and can reside on a hard drive 150 of host device. The MFD driver program can be activated through an application interface so that a user may generate a rendering job with the MFD driver for processing by the MFD 140. The data-processing system 110 also includes a GUI 125 for communicating MFD features for processing, for example, the rendering job to a user and accepting the user's selection of available MFD features. The user interface 125 displays information and receives data through device display and/or the keyboard/mouse combination. The interface 125, also serves to display results, whereupon the user may supply additional inputs or terminate a given session. The data-processing system 110 can be, for example, any computing device capable of being integrated within a network, such as a PDA, personal computer, cellular telephone, point-of-sale terminal, server, etc.

Note that the user interface as utilized herein generally refers to a type of environment that represents programs, files, options and so forth by means of graphically displayed icons, menus, and dialog boxes on a screen. The input device of the multifunction device 140 includes can be a local user interface, such as a touch-screen display or separate keypad and display or a memory fob or the like as discussed above. Alternatively or additionally, the input device can be a wireless port that receives a wireless signal containing constraint data from a portable device. The wireless signal can be an infrared or electromagnetic signal. A system administrator may input constraint data through the local user interface by manipulating the touch screen, keypad, or communicating via wireless messages through the wireless port. The administrator's portable device that communicates wirelessly can be a personal digital assistant (PDA), or the like, as noted above.

The following description is presented with respect to embodiments of the present invention, which can be embodied in the context of a data-processing system 110 and MFD 140 depicted in FIG. 1. The present invention, however, is not limited to any particular application or any particular environment. Instead, those skilled in the art will find that the system and methods of the present invention can be advantageously applied to a variety of system and application software, including database management systems, word processors, and the like. Moreover, the present invention can be embodied on a variety of different platforms, including Macintosh, UNIX, LINUX, and the like. Therefore, the description of the exemplary embodiments, which follows, is for purposes of illustration and not considered a limitation.

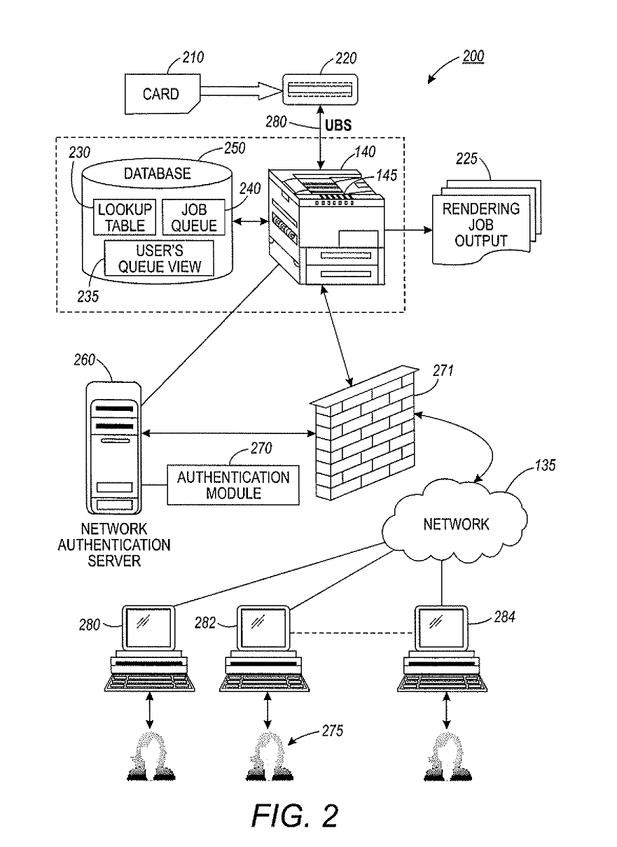

FIG. 2 illustrates a block diagram of a card based authentication system 200 associated with the multifunction device 140, in accordance with the disclosed embodiments. Note that in FIGS. 1-5, identical or similar blocks are generally indicated by identical reference numerals. The authentication system 200 generally includes a network 135 connecting the multifunction device 140 with one or more data-processing systems 280, 282 and 284 and a network authentication server 260. Data-processing system 110 depicted in FIG. 1 can be, for example, a server. The multifunction device 140 further includes a card reader 220 and a database 250. The card reader 220 can be coupled to the multifunction device 140 via a USB communication line 280 (e.g. a USB data cable). The authentication system 200 can be employed for releasing stored rendering job (e.g., print job) with respect to a user by swiping an electronically readable card 210.

Note that the electronically readable card 210 can be for example, a magnetic stripe card, a proximity card, a smart card, a credit card, a frequent flyer card and key fobs which include a large unique number or a card serial number. The authentication system 300 can operate with any type of cards which is electronically readable, e.g., by magnetic stripe or RFID, and to result in some unique identifier, e.g., one or more numbers or letters. However, it will be apparent to those of skill in the art that other cards can be employed as desired without departing from the scope of the invention.

The MFD can be, for example, an office machine, which incorporates the functionality of multiple devices in one, so as to provide centralized document management, document distribution and production in a large-office setting and the like. The typical MFD may act as a combination of a printer, scanner, photocopier, fax and e-mail. In general, the multifunction device 140 can be employed to perform a rendering output function (e.g., printing, scanning, copying, faxing, etc) within a networked environment.

The rendering job from the data-processing systems 280, 282 and 284 associated with one or more users 275 can be securely transmitted to the multifunction device 140 via a firewall 271. The authentication server 260 manages and controls the rendering process including authenticated rendering. An authentication module 270 associated with the network authentication server 260 can be adapted for configuring network credentials with respect to the users 275 and storing the network credentials in the database 250 associated with the MFD 140. Such a module is typically implemented in the context of a software application, and/or modules (e.g., hardware and/or software) that enable image processing and control functions such as those described herein with respect to FIGS. 1-2.

Note that as utilized herein, the term “module” may refer to a physical hardware component and/or to a software module. In the computer programming arts, such a software “module” can be implemented as a collection of routines and data structures that performs particular tasks or implements a particular abstract data type. Modules of this type are generally composed of two parts. First, a software module may list the constants, data types, variable, routines, and so forth that can be accessed by other modules or routines. Second, a software module can be configured as an implementation, which can be private (i.e., accessible only to the module), and which contains the source code that actually implements the routines or subroutines upon which the module is based.

Therefore, when referring to a “module” herein, the inventors are generally referring to such software modules or implementations thereof. The methodology described herein can be implemented as a series of such modules or as a single software module. Such modules can be utilized separately or together to form a program product that can be implemented through signal-bearing media, including transmission media and recordable media. The present invention is capable of being distributed as a program product in a variety of forms, which apply equally regardless of the particular type of signal-bearing media utilized to carry out the distribution.

The authentication system 200 can be a card based system that authenticates the users 275 via any electronically readable card 210. The user can swipe the readable card 210 on the card reader 220 to gain access to the stored rendering jobs associated with the user in the multifunction device 140. The rendering job 225 can be rendered by the MFD 140 in a case where a user succeeds in authentication by inputting the network credentials. The authentication system 200 can provide increased capability and flexibility, reduced complexity and improved speed, accuracy and ease of use via card swipe.

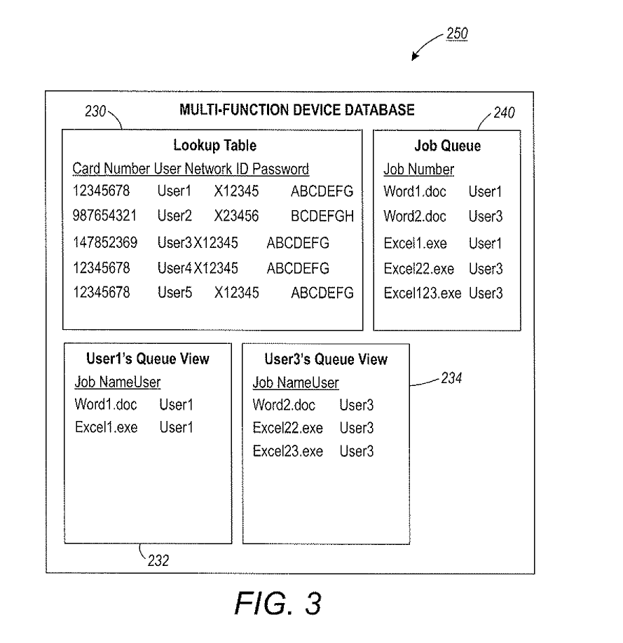

FIG. 3 illustrates an exemplary view of the database 250 associated with the MFD 140, in accordance with the disclosed embodiments. The database 250 associated with the MFD 140 generally stores network credentials associated with the users 275 in a lookup table 230, a rendering job queue 240 and a job queue 234 associated with each user. The job queue 240 includes a stack of rendering jobs 225 submitted by the users from the data-processing system 280, 282 and 284. The electronically readable card 210 can be swiped with respect to the MFD card reader 220 in order to authenticate the user 275 based on the stored credential associated with the electronically readable card 210 in the lookup table 230.

The user can be prompted to add the card 210 when an unknown card is detected. The network credentials 230 can be entered manually at the user interface 145 and transmitted to the authentication server (LDAP, SMB, Kerberos etc) 260 in order to add the unknown card. The LDAP server is a directory server that provides an LDAP authentication service. The LDAP server possess functions for managing information such as a title of a user using the authenticated system 300 and environment and searching for user information by using a user ID or the like as a key. The card number can be stored in the secure local database 250 along with the network credentials 230 for future use if the authentication is successful.

The database 250 can be sized to accept a reasonable number of cards and the MFD 140 is only aware of its own users. The MFD 140 can be configured to hold all rendering jobs transmitted and release the jobs to authenticated users. The MFD 140 posses the ability to clear the database 250 if the MFD 140 is relocated and the individual users can be deleted if they no longer use the specific MFD 140. The MFD 140 can be unlocked if the card 210 is recognized in order to provide access to an appropriate service. If the user navigates to the job queue the MFD 140 then compares a username associated with the rendering job in the job queue 240 and the username associated with the card 210 and displays a user queue such as queue 232 and 234 associated with each user. The individual job can then be selected and released or all jobs can be released immediately after the card 210 is recognized. Each user can view only the respective job queue 235 in order to enhance security.

The authentication module 270 can be optionally programmed to permit specific users to render without a job hold if so desired. The MFD 140 can be designed with a default time limit for aging of accounts. The accounts not employed for a programmable amount of time can be deleted and the default value can be modified by a system administrator if desired. In the event that the user's credentials (password) expire, the user can be prompted to re-enter the credentials which can then overwrite the previously stored data.

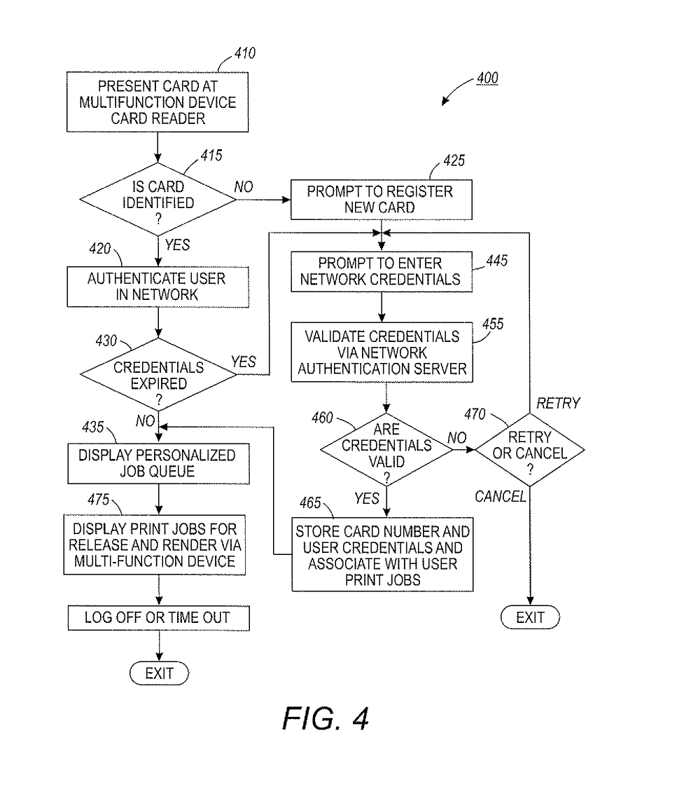

FIG. 4 illustrates a high-level flow chart of operations illustrating logical operational steps of a method 400 for securely releasing stored rendering jobs utilizing the electronically readable card 210, in accordance with the disclosed embodiments. The card 210 associated with the user 275 can be swiped via the card reader 220, as illustrated at block 410. A determination can be made whether the card 210 is already registered, as depicted at block 415. If the card is already registered the user can be authenticated, as indicated at block 420. A determination can be then made whether the credentials are expired, as depicted at block 430. If the credentials are not expired the personalized job queue such as queue 232 and 234 can be displayed to the user, as illustrated at block 435. The jobs can be selected and rendered, as indicated at block 475.

If the card 210 is not registered then the user can be prompted to register a new card, as depicted at block 425. Thereafter, as illustrated at block 445, the user can be prompted to enter network credentials if the network credentials are expired. The credentials can be then validated via the network authentication server 260, as depicted at block 455. A determination can be made whether the credentials are valid, as indicated at block 460. If the credentials are valid the card number and other credentials can be stored and associated with the respective user rendering jobs in the job queue 240, as illustrated at block 465. Otherwise, the user can be prompted to retry or cancel, as indicated at block 470. If the user selects to retry the process can be continued from the block 445, otherwise the process can be exited.

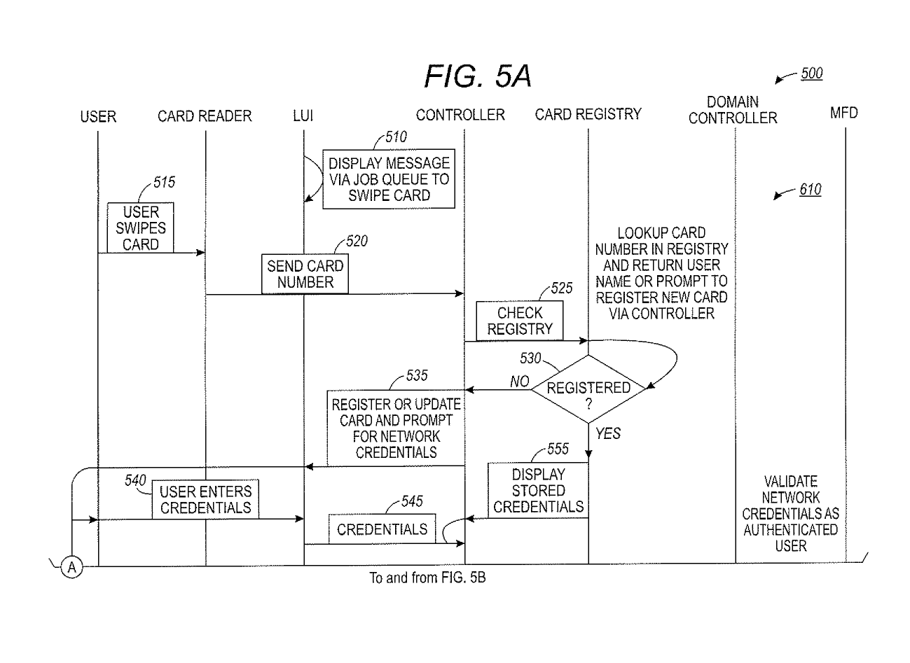

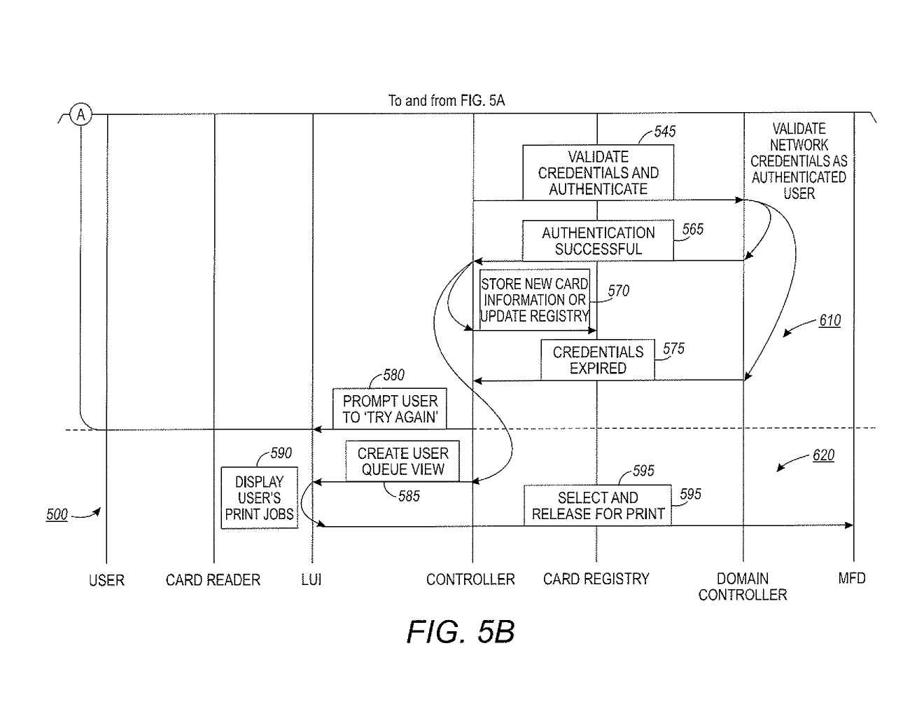

FIG. 5A and FIG. 5B illustrate a sequence diagram 500 for securely releasing a rendering job utilizing the electronically readable card 210 at the MFD 140, in accordance with the disclosed embodiments. The sequence diagram with respect to an authentication process, a new card registration process and updating an expired credential process, are illustrated at block 610. The sequence diagram for the release of the rendering job is illustrated at block 620. The job request may include the performance of one or more of a combination of services such as printing, scanning, filing, translation, enrichment, correction, conversion, etc. The job queue presents a blocking screen with a message to swipe the readable card 210 or register new card, as depicted at block 510. The user swipes the card 210 and the card number can be transmitted to the authentication server 260, as illustrated at block 515 and 520. Note that the term “readable card” refers to any type of card or memory device for storing user information and capable of being read by an electronic device.

The MFD controller can further check for card registry in the look-up table 230, as illustrated at block 525. A determination can be made whether the card 210 is registered, as illustrated at block 530. If the card 210 is not registered, the card can be registered, updated and prompted for network credentials, as depicted at block 535. The user can enter the credentials, as illustrated at blocks 540 and 545. If the card is registered the stored credentials can be displayed, as indicated at block 555. The credentials can be validated and authenticated, as indicated at block 560. If the credentials are good the authentication is successful, as depicted at block 565.

Thereafter, as illustrated at block 570 the new card details can be stored and the registry can be updated. If the credentials are expired the user can be prompted to re-enter the credentials, as indicated at block 580. If the card is authenticated a user queue view can be created, as depicted at block 585. The user rending jobs can be displayed and the jobs can be selected and released, as illustrated at blocks 590 and 595. The system and approach described herein validates the user credentials before accepting the card into the database and securely stores authenticated user credentials so they need not be entered every time the MFD is utilized.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A card based authentication method, said method comprising:
entering network credentials via a user interface associated with a multifunction device to register a card having card details and validate said card and said network credentials prior to storing in a database and associating said network credentials with said card;
swiping said card via a card reader associated with said multifunction device to authenticate a user based on said network credentials with respect to said card; and
unlocking said multifunction device if said card is recognized in order to thereafter provide access to a stored rendering job associated with said user and securely release said rendering job based on a user selection.

2. The method of claim 1 further comprising prompting a user to register said card if said card is not recognized by said multifunction device.

3. The method of claim 1 further comprising storing a card number associated with said card in said database along with said network credentials.

4. The method of claim 1 further comprising holding said rendering job associated with a username in a job header at said multifunction device for release via said card swipe.

5. The method of claim 1 wherein unlocking said multifunction device if said card is recognized, further comprises:
comparing a username associated with said card with a username of said stored rendering job in a job queue; and
displaying said rendering job associated with said user after said card is recognized.

6. The method of claim 1 further comprising deleting said network credentials stored in said database associated with said multifunction device if said multifunction device is relocated.

7. The method of claim 1 further comprising deleting said network credentials if said network credentials is not accessed for a predefined time period.

8. The method of claim 1 further comprising prompting said user to re-enter said network credentials if said network credentials associated with said user are expired.

9. The method of claim 1 wherein said card comprises an electronic readable card.

10. The method of claim 1 further comprising configuring said card to comprise at least one of the following types of cards:
a magnetic strip card;
a credit card;
a proximity card;
a frequent flyer card;
a smart card; and
a USB key fob.

11. A card based authentication system, said system comprising:
a processor;
a data bus coupled to said processor; and
a computer-usable medium embodying computer code, said computer-usable medium being coupled to said data bus, said computer program code comprising instructions executable by said processor and configured for:
entering network credentials via a user interface associated with a multifunction device to register a card having card details and validate said card and said network credentials prior to storing in a database and associating said network credentials with said card;
swiping said card via a card reader associated with said multifunction device to authenticate a user based on said network credentials with respect to said card; and
unlocking said multifunction device if said card is recognized in order to thereafter provide access to a stored rendering job associated with said user and securely release said rendering job based on a user selection.

12. The system of claim 11 wherein said instructions are further configured for prompting a user to register said card if said card is not recognized by said multifunction device.

13. The system of claim 11 wherein said instructions are further configured for storing a card number associated with said card in said database along with said network credentials.

14. The system of claim 11 wherein said instructions are further configured for holding said rendering job associated with a username in a job header at said multifunction device for release via said card swipe.

15. The system of claim 11 wherein unlocking said multifunction device if said card is recognized, further comprises:
comparing a username associated with said card with a username of said stored rendering job in a job queue; and
displaying said rendering job associated with said user after said card is recognized.

16. The system of claim 11 wherein said instructions are further configured for deleting said network credentials stored in said database associated with said multifunction device if said multifunction device is relocated.

17. The system of claim 11 wherein said instructions are further configured for deleting said network credentials if said network credentials are not accessed for a predefined time period.

18. The system of claim 11 wherein said instructions are further configured for prompting said user to re-enter said network credentials if said network credentials associated with said user are expired.

19. The system of claim 11 wherein said card comprises at least one of the following types of cards:
a magnetic strip card;
a credit card;
a proximity card;
a frequent flyer card;
a smart card; and
a USB key fob.

20. A computer-usable, said computer-usable medium embodying computer program code, said computer program code comprising computer executable instructions configured for:
entering network credentials via a user interface associated with a multifunction device to register a card having card details and validate said card and said network credentials prior to storing in a database and associating said network credential with said card;
swiping said card via a card reader associated with said multifunction device to authenticate a user based on said network credentials with respect to said card; and
unlocking said multifunction device if said card is recognized in order to thereafter provide access to a stored rendering job associated with said user and securely release said rendering job based on a user selection.
